(19) United States
(12) Patent Application Publication
(10) Pub. No.: US 2012/0085444 A1
(43) Pub. Date: Apr. 12, 2012

(54) Switching device for sanitary fittings, in particular showers, bathtubs and the like

(76) Inventor: Patrizia Bollo, Cavaglio d'Agogna (NO) (IT)

(21) Appl. No.: 13/199,929

(22) Filed: Sep. 13, 2011

(30) Foreign Application Priority Data
Oct. 8, 2010 (IT) MI2010A001841

(51) Int. Cl. F16K 11/00

(52) U.S. Cl. 137/625

(57) ABSTRACT

A switching device for sanitary fittings such as showers and bathtubs, characterized in that said switching device comprises a control rod element movable in a support associated with a mixing cartridge, said control rod element having at least two water delivery positions thereat a mixed water flow is conveyed either to one or to the other of two or more separated directrix lines corresponding to two or more separated using places.

### BACKGROUND OF THE INVENTION

The present invention relates to a switching device, in particular for sanitary fittings such as showers, bathtubs and the like.

As known, in showers and bathtubs switching devices designed for properly directing water flows to desired places, such as the shower blower assembly located at the top of the shower box, the side shower assembly including related flexible connecting hoses, multiple side jet assemblies and so on, are conventionally used.

Prior switching devices comprise rotary control assemblies, with two or more outlets and a pawl or the like device for signaling that a target position is reached.

Thus, it should be apparent that the above prior switching devices are custom designed and made for each desired application which involves a great expense for the required molds, tools and the like.

From a functional standpoint, moreover, prior switching devices have been found very difficult to be driven, due to an intrinsic operation resistance, which is usually aggravated by the fact that said devices are usually operated by users having wet or soaped hands.

### SUMMARY OF THE INVENTION

Thus, the aim of the present invention is to provide such a switching device construction, particularly for sanitary fittings such as showers, bathtubs and the like, adapted to overcome the above mentioned drawbacks of prior switching devices intended for the same applications.

Within the scope of the above aim, a main object of the invention is to provide such a switching device which is very simple construction-wise and reliable in operation.

Another object of the present invention is to provide such an easily operated switching device and the use of which would be self-evident to the user.

Yet another object of the present invention is to provide such a switching device which may be made starting from already existing elements and materials forming conventional mixing cartridges and which is accordingly very competitive from a mere economic standpoint.

Yet another object of the present invention is to provide such a switching device which, owing to its specifically designed construction, is very reliable and safe in operation.

According to one aspect of the present invention, the above aims and objects, as well as yet other objects, which will become more apparent hereinafter, are achieved by a switching device, particularly for sanitary fittings such as showers, bathtubs and the like, characterized in that said switching device comprises a driving rod element movable in a support assembly associated with a mixing cartridge.

Said driving rod element defines at least two water delivery positions, thereat a mixed water flow is directed either to one or to the other of two separated directions corresponding to two or more separated using regions.

Said driving rod is movable in said support assembly according to a restrained path defined by two directrix lines arranged according to a V pattern having a set “opening” of the V pattern legs.

Said driving or control rod element comprises moreover a central closure position located at the vertex of the V-shape.

Thus, by driving or displacing the rod element in either one or the other directrix line directions, a continuous opening movement is achieved, from a closure position, corresponding to the central position, to a full opening position, corresponding to the vertex point of one of the two V-shape legs, thereby allowing to control or adjust the outlet water flow amount only in a single direction.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is an exploded perspective view of a joystick type of cartridge made starting from a conventional mixing cartridge assembly:

FIG. 2 is a further exploded perspective view of the switching device according to the present invention;

FIG. 3 is yet another perspective view of the inventive device, being shown in assembled conditions thereof;

FIG. 4 is yet another perspective view showing the device of the preceding figures as applied to a mixing cartridge;

FIG. 5 is a perspective view of a control or drive device of a mixing cartridge having an idle or like movement, of a per se known type, which is replaced by the device according to FIG. 3;

FIG. 6 is yet another exploded perspective view of a modified embodiment of the present invention, as applied to the cartridge shown in FIG. 4; and

FIG. 7 is yet another perspective view of the device shown in FIG. 6, but illustrated in assembled conditions thereof.

### DESCRIPTION OF THE PREFERRED EMBODIMENTS

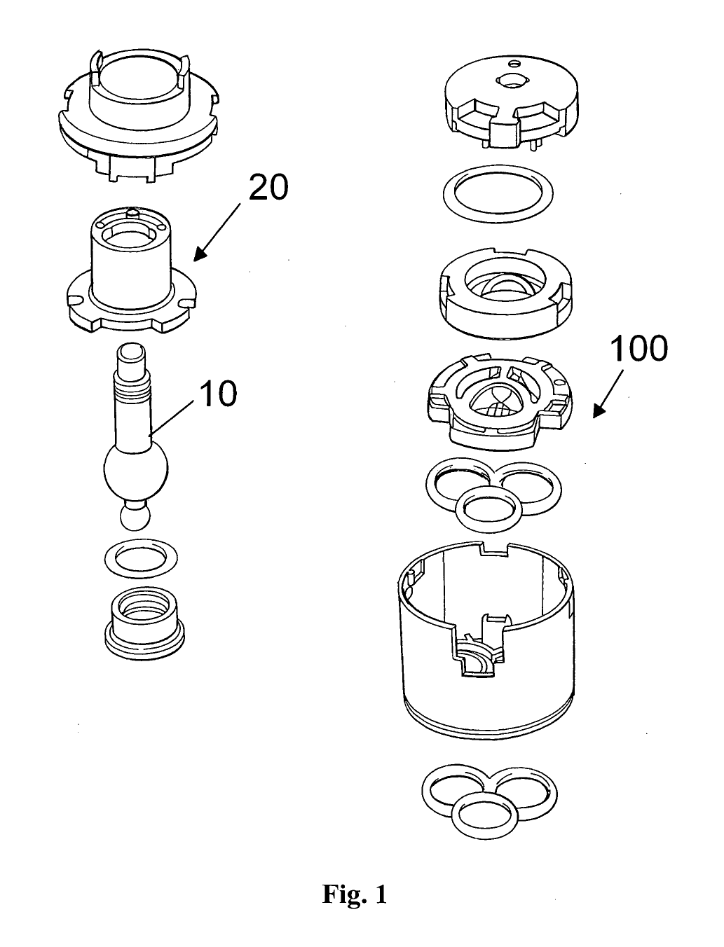

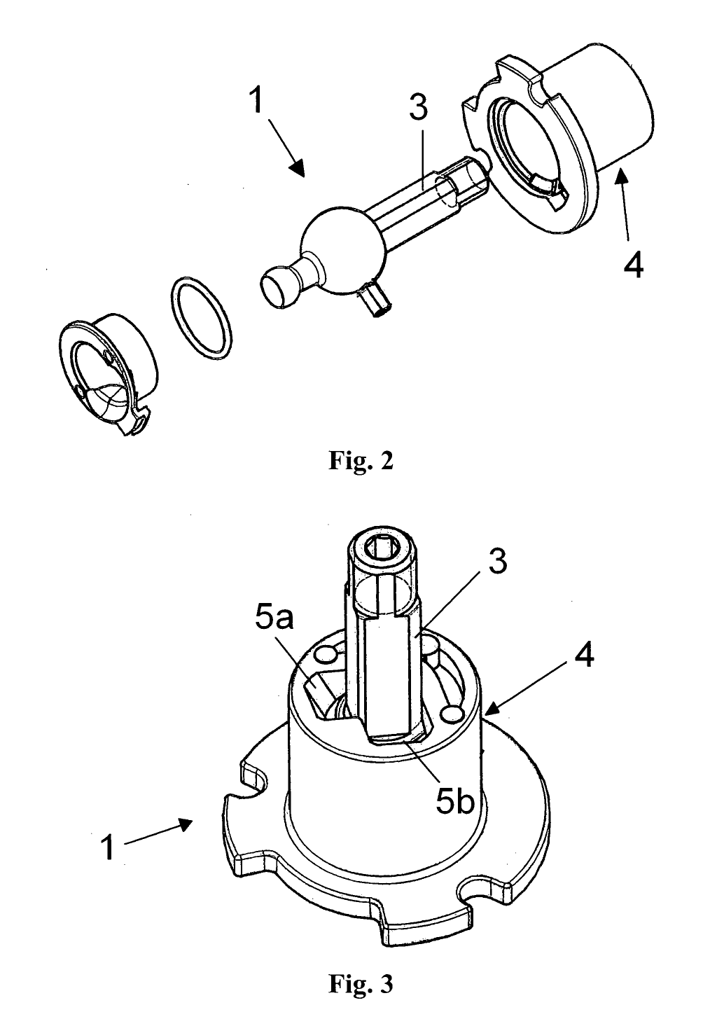

With reference to the number references of the above mentioned figures, the switching device according to the present invention, which has been generally indicated by the reference number 1, comprises a V-shape control or drive unit applied to a body of a mixing cartridge 100, as shown in FIG. 1.

The V-shape control or drive unit, which may depend on the movement performed by its control rod, is made by replacing the rod element 10 and the detail or component 20, the latter being usually made of a plastic material, including therein the rod element of a conventional mixing cartridge of the type driven by a joystick movement as shown in FIG. 1.

More specifically, said cartridge 100 may be custom made depending on the intended application or it may be derived from a conventional cartridge, either including or not an idle movement.

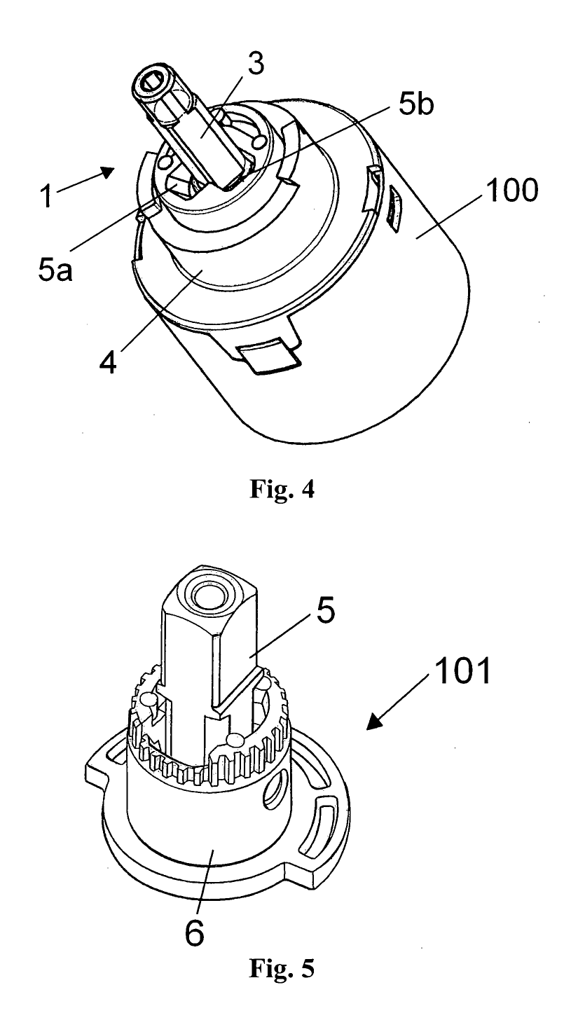

The device 1, according to the present invention, comprises a rod element 3 movable in a support assembly 4, through a restrained path defined by two V arranged directrix lines 5a and 5b, as clearly shown in FIGS. 3 and 4.

At a closing or closure position of the device, the rod 3 is arranged centrally at the V-shape vertex, thereby the switching device may be used in all applications requiring a closure movement, for example in association with a thermostatic type of cartridge.

Thus, by displacing or driving the rod element 3 in a direction of one of said two directrix lines 5a and 5b, a continuous opening movement is achieved, from a closure position to a full opened position, thereby allowing the outlet water flow to be controlled exclusively according to a direction, differently from a conventional or prior switching device, in which such an operation is not provided or possible.

By suitably locating the switching device according to the present invention, it may be used in a per se self-evident manner, for example with the top blowing assembly with an upward type of lever movement and side jet assemblies with a lateral type of movement.

Another advantage of the switching device according to the present invention is that it may be easily used by handicapped persons not able of easily driving prior devices having a rotary type of controlling movement.

In this connection, the fact to be pointed out is that the switching device according to the present invention, provided with a central closure position and unidirectional operating paths, may be made by using inner device components of suitable configurations and shapes, thereby providing not only two, but three or more, outlets, according to the same inventive driving idea.

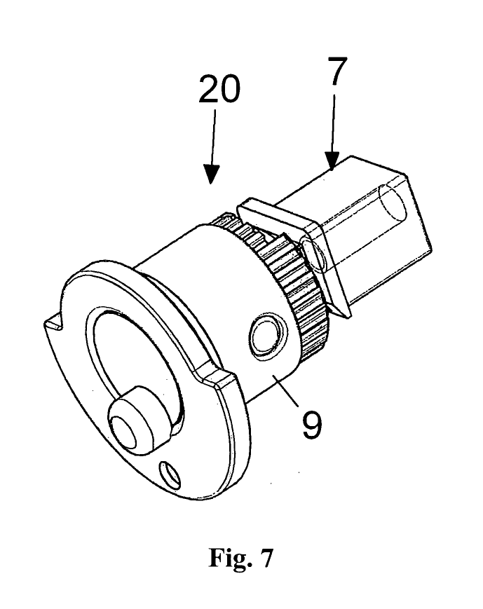

FIGS. 6 and 7 show a modified switching device, indicated generally by the reference number 20, according to a further aspect of the present invention.

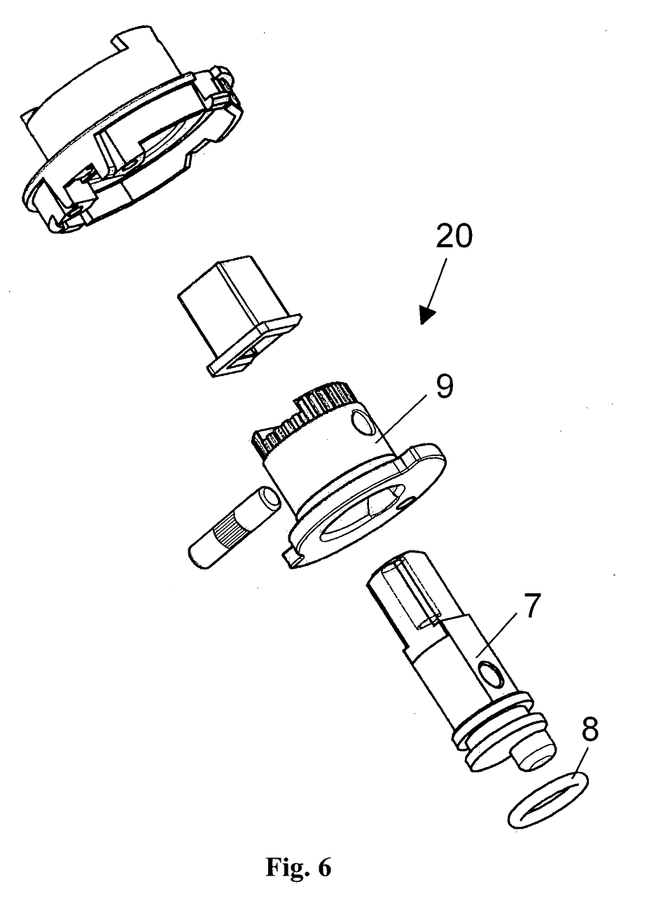

In particular, such a modified switching device 20 may also be derived from the control or drive unit of a conventional mixing cartridge 101 preferably driven by an idle or the like movement, by simply replacing the starting control or drive rod element 5, and, if necessary, the related support assembly 6 as clearly shown in FIG. 5.

The device 20 according to this modified embodiment of the invention comprises a rod element 7, of a suitable shape, and designed for holding ceramics disc elements always in an opening position thereof.

More specifically, said rod element 7, being supported by a support assembly 9, may comprise a cushioning rubber element 8, such as a rubber-ring or the like, for compensating possible clearances of the operating mechanism.

The achieved movement, which is exclusively a rotary one, is characterized by a very good operating softness, thereby preventing any drawbacks in operating the device with wet or soaped hands.

The inventive switching device does not comprise a closure position, and has a very advantageous feature not provided by similar devices, that is the possibility of conveying water not only to a target outlet, corresponding to hand right or left rotary end positions, but simultaneously also in two directions, for example to the shower blowing assembly and the side jet assemblies without requiring to perform complex connections or use specifically designed holding bodies.

Such a bidirectional simultaneous use does not provide preset water flow rates, as in devices with connections outside of the cartridge, but may be easily changed at will depending on requirements.

The possibility of providing simultaneous delivery outlets is assured by very good water delivering performance, notwithstanding a small size of the switching device, having a diameter of about 35 mm.

It has been found that the invention fully achieves the intended aim and objects.

In practicing the invention, the used materials, as well as the contingent size and shapes, can be any, according on requirements.

1. A switching device for sanitary fittings such as showers and bathtubs, characterized in that said switching device comprises a control rod element movable in a support associated with a mixing cartridge, said control rod element having at least two water delivery positions thereat a mixed water flow is conveyed either to one or to the other of two or more separated directrix lines corresponding to two or more separated using places.

2. A switching device, according to claim 1, characterized in that said control or drive rod is movable in said support assembly according to a restrained driving path defined by two directrix lines arranged with a V-shape, said control rod element having moreover a central closure position at a vertex point of said V-shape.

3. A switching device, according to claim 1, characterized in that, as said control rod is displaced in a direction of one of said two directrix lines, said device is continuously opened, from a closure position, corresponding to said central closure position, to a fully opened position, corresponding to said vertex point of one of two legs of said V-shape, thereby allowing to control the outlet water flow rate in a single direction only.

4. A switching device, according to claim 1, characterized in that said switching device comprises three or more directrix lines to controllably convey a water flow to three or more separated using places.

5. A switching device, according to claim 1, characterized in that said control rod element is so shaped as to hold ceramics disc elements of a mixing cartridge, said switching device is applied to, always at an opening position.

6. A switching device, according to claim 1, characterized in that said control rod element comprises a cushioning rubber element, of a O-ring configuration, for compensating possible clearances in said switching device.

7. A switching device, according to claim 1, characterized in that said control rod element performs only a rotary movement thereby allowing to convey water not only to a target outlet, at limit right or left rotary positions, but also simultaneously in two directions, one being to a shower blowing assembly and the other to shower side jet assemblies.

8. A switching device, according to claim 1, characterized in that said device is adapted to be simultaneously driven in two operating directions without providing preset water flow rates, the water flow rate being a variable water flow rate.

9. A switching device, according to claim 1, characterized in that said switching device has a diameter of about 35 mm.
